(19) United States
(12) Patent Application Publication
(10) Pub. No.: US 2026/0318049 A1
(43) Pub. Date: Oct. 15, 2026

(54) Method For Monitoring An Operation Of A Work Machine Arm

(71) Applicant: Caterpillar Inc., Peoria, IL (US)

(72) Inventors: Arick M. Bakken, Raleigh, NC (US); Benjamin J. Hodel, Dunlap, IL (US); Adam Martin Nackers, Washington, IL (US); Rustin Glenn Metzger, Carlock, IL (US)

(21) Appl. No.: 19/482,127

(22) PCT Filed: Apr. 11, 2024
(86) PCT No.: PCT/US2024/024060

§ 371 Date: Nov. 6, 2025

(30) Foreign Application Priority Data
May 15, 2023 (GB) 2307188.9

(51) Int. Cl. E02F 9/26; E02F 3/32; E02F 3/43; E02F 3/96

(52) U.S. Cl. CPC E02F 9/264; E02F 3/32; E02F 3/435; E02F 3/963

(57) ABSTRACT

In this disclosure, there is provided a method for monitoring an operation of a work machine. The work machine comprises a body and an arm. The arm comprises: a stick, the stick comprising a proximal end pivotably connected to the body at a stick pivot and configured to rotate about the stick pivot; a tool comprising a proximal end pivotably connected to a distal end of the stick at a tool pivot and configured to rotate about the tool pivot; and a tool position sensor, configured to determine a position of the tool. The method comprises determining, based on the determined position of the tool, a tool angle of rotation with respect to the stick; and determining an output signal, based on comparing the tool angle of rotation with respect to the stick to a target range of tool angles.

### FIELD OF THE DISCLOSURE

The disclosure relates to the field of work machines.

### BACKGROUND

A work machine may comprise a body and an arm for carrying out operations such as digging, grading or scooping. The work machine may be an excavator, a backhoe loader, a wheel loader or the like.

The arm comprises a stick and a tool, such as a bucket.

In a first type of work machine, the arm further comprises a boom. The boom may be pivotably connected to the body at a proximal end of the boom and the stick may be pivotably connected to the boom at a distal end of the boom and a proximal end of the stick. The tool may be pivotably connected to a distal end of the stick.

In a second type of work machine, the stick may be pivotably connected to the body at a proximal end of the stick and may be pivotably connected to a tool, such as a bucket, at a distal end of the stick.

The arm may be controlled by a user via a control panel. Alternatively, or additionally, the arm may be controlled by a controller following an autonomous work algorithm. In this way, the arm may be moved in order to collect material in the bucket.

The work machine may be provided with hydraulic actuators which make use of an internal combustion engine as an energy source for the arm. The work machine may be provided with electromechanical actuators which use a battery as an energy source for the arm. In either case, there is limited energy availability until the work machine needs to be refuelled and/or recharged.

Energy efficiency of the arm may depend on factors such as position of the arm, ground conditions, speed of movement of the arm, sharpness of cutting tools on a bucket and the like. In many cases, the energy efficiency is not scrutinised. However, even when a full bucket is achieved, an amount of energy used to achieve this may be different depending upon technique. For this reason, the arm may not be moved as efficiently as possible when operated by a user and/or when following an autonomous work algorithm. This in turn may lead to a situation where more frequent refuelling and/or recharging is required, limiting the availability of the work machine for carrying out work operations.

Against this background, various aspects of this disclosure provide improvements for monitoring an arm of a work machine.

### SUMMARY OF THE DISCLOSURE

In some aspects of this disclosure, there is provided:
a method for monitoring an operation of a work machine, the work machine comprising a body and an arm, the arm comprising:
a stick, the stick comprising a proximal end pivotably connected to the body at a stick pivot and configured to rotate about the stick pivot;
a tool comprising a proximal end pivotably connected to a distal end of the stick at a tool pivot and configured to rotate about the tool pivot;
a tool position sensor, configured to determine a position of the tool;
wherein the method comprises:
determining, based on the determined position of the tool, a tool angle of rotation with respect to the stick; and
determining an output signal, based on comparing the tool angle of rotation with respect to the stick to a target range of tool angles.

In this way, by facilitating an analysis of arm positioning, it is possible to improve and/or monitor the efficiency of the work machine.

In some aspects of this disclosure, there is provided:
a work machine comprising a body and an arm, the arm comprising:
a stick, the stick comprising a proximal end pivotably connected to the body at a stick pivot and configured to rotate about the stick pivot;
a tool comprising a proximal end pivotably connected to a distal end of the stick at a tool pivot and configured to rotate about the tool pivot;
a tool position sensor, configured to determine a position of the tool;
a data processing apparatus for monitoring the operation of the work machine, the data processing apparatus being configured to:
determine, based on the determined position of the tool, a tool angle of rotation with respect to the stick; and
determine an output signal, based on comparing the tool angle of rotation with respect to the stick to a target range of tool angles.

In this way, by facilitating an analysis of arm positioning, it is possible to improve and/or monitor the efficiency of the work machine.

### BRIEF DESCRIPTION OF THE DRAWINGS

A specific embodiment of the disclosure will now be described, by way of example only, with reference to the accompanying drawings in which:

FIG. 1 shows a work machine.

FIG. 2 shows an example of the first type of work machine.

FIG. 3 shows a tool angle of rotation with respect to a stick on a work machine.

FIG. 4 shows a tool angle of rotation with respect to a vertical line, a stick angle of rotation with respect to a vertical line, and a tool angle of rotation with respect to a stick, on a work machine.

FIG. 5 shows a method for monitoring the operation of a work machine.

FIG. 6 shows a method for determining a tool angle of rotation with respect to a stick

FIG. 7 shows an embodiment of the method further comprising a step of determining whether an operation is in progress and/or a step of determining a suggested action.

FIG. 8 shows a work machine having a first tool angle of rotation with respect to the stick.

FIG. 9 shows a work machine having a second tool angle of rotation with respect to the stick.

FIG. 10 shows (top) a plot at various time points as a digging operation is carried out of
a tool angle of rotation with respect to a vertical line;
a stick angle of rotation with respect to a vertical line;
a sum of the tool angle of rotation with respect to the vertical line the stick angle of rotation with respect to the vertical line; and
the tool angle of rotation with respect to the stick
and (bottom) a table summarising the data from the plot.

### DETAILED DESCRIPTION

According to one or more aspects of this disclosure a method for monitoring an operation of a work machine is provided.

In one or more aspects of this disclosure, a work machine comprises a body and an arm, the arm connected at a proximal end to the body and extending from the body towards a tool or tool connector at the distal end of the arm. A direction and/or location along the arm towards or closer to the body will be referred to as a proximal direction and/or a proximal location. A direction and/or location along the arm towards or closer to the tool end of the arm will be referred to as a distal direction and/or a distal location.

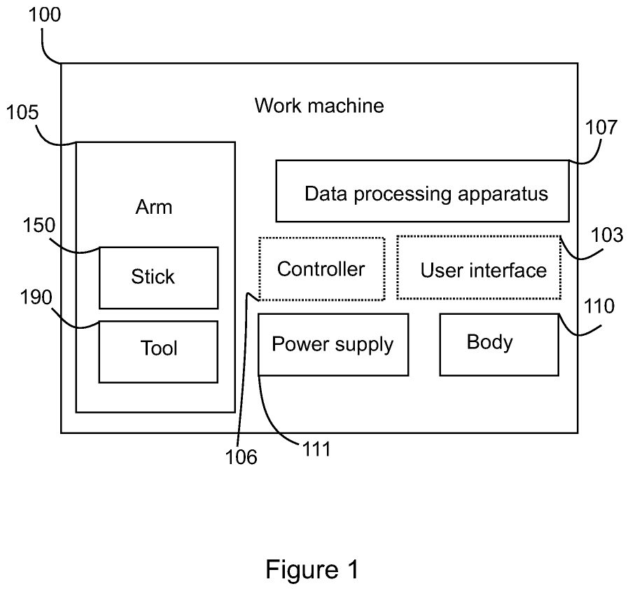

FIG. 1 shows an example of a work machine 100. The work machine 100 comprises an arm 105. The arm 105 may be used for carrying out a work operation, for example a digging operation, a grading operation and/or the like. The work machine may further comprise a power supply 111 and a data processing apparatus 107. The arm 105 may make use of mechanical power provided by the power supply 111. The data processing apparatus 107 may, by following a method according to this disclosure, be used to process data obtained about movements of the arm 105. In this way, the work operation may be monitored. By monitoring movements of the arm 105, it may be possible to improve the efficiency of power used by the arm 105, resulting in more efficient use of power from the power supply 111.

The work machine 100 further comprises a body 110. The arm 105 comprises a stick 150 and a tool 190, such as a bucket 190. The arm 105 may be pivotably connected to the body 110. As has already been explained, the work machine may further comprise a power supply for providing mechanical power to the arm 105. The power supply 111 may be an electrical power supply, comprising a battery and/or a connection to an energy grid. The electrical power supply may be configured to power a motor. The power supply 111 may be an internal combustion engine. The power supply 111 may be a gas turbine. In some embodiments, the power supply 111 may configured to power a hydraulic pump, the hydraulic pump configured to pump hydraulic oil to a cylinder of an actuation assembly and/or a motor.

In some embodiments, the work machine 100 may further comprise a user interface 103. The data processing apparatus 107, by following a method according to this disclosure, may determine an output signal. In some embodiments, the output signal may be provided to the user interface 103. In this way, a user may be provided information determined by the data processing apparatus 107 about movements of the arm 105. Based on the output signal, the user may adapt an operation such that efficiency of power used by the arm 105 is increased.

Additionally and/or alternatively, the work machine 100 may further comprise a controller 106 for controlling the work machine 100. For example, the controller 106 may be configured to autonomously control the work machine 100. In some embodiments, the output signal may be provided to the controller 106. In this way, the controller 106 may be provided information determined by the data processing apparatus 107 about movements of the arm 105. Based on the output signal, the controller 106 may adapt an operation such that efficiency of power used by the arm 105 is increased.

As will be clear from this disclosure, the method for monitoring a work machine provided herein may apply to one or more types of work machines, such as an excavator, a backhoe loader, a wheel loader, or the like.

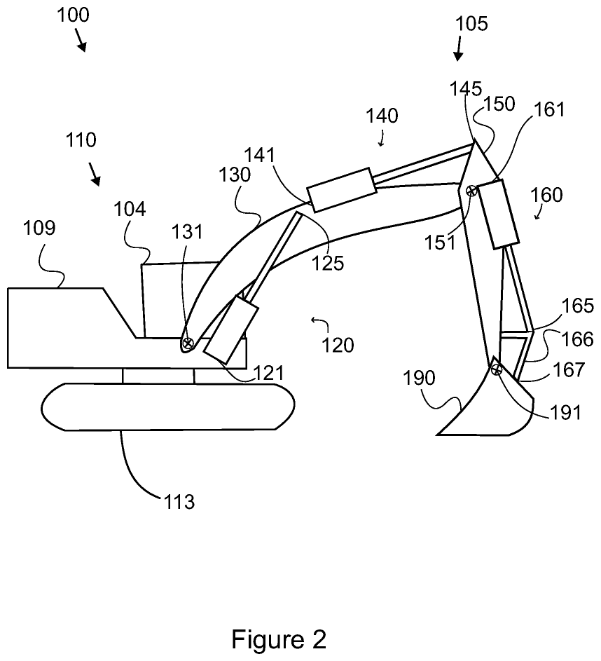

In a first type of work machine 100, the arm 105 further comprises a boom 130. FIG. 2 shows an example of the first type of work machine 100. The boom 130 may be pivotably connected to the body 110 at a proximal end of the boom 131 and the stick 150 may be pivotably connected to the boom 130 at a distal end of the boom 151 and a proximal end of the stick 151. The tool 190 may be pivotably connected to a distal end of the stick 191. Examples of the first type of work machine 100 may be an excavator, a backhoe loader, or the like.

In a second type of work machine 100, the stick may be pivotably connected to the body at a proximal end of the stick and may be pivotably connected to a tool, such as a bucket, at a distal end of the stick. An example of the second type of work machine 100 may be a wheel loader or the like.

By way of example only, the aspects of this disclosure will now be explained in detail with reference to the first type of work machine 100.

Referring to FIG. 2, the work machine 100 comprises a body 110 and an arm 105. The body 110 may comprise a chassis 109, a cab 104, and a ground propulsion assembly comprising tracks 113 (and/or wheels). The arm may comprise a boom 130 pivotably connected at a proximal end of the boom to the chassis 109 at a boom pivot 131. The arm 105 further comprises a stick 150 which may be pivotably connected at a proximal end of the stick to a distal end of the boom 130 at a stick pivot 151. In other embodiments, not shown in FIG. 2, such as the second type of work machine referred to above, the stick 150 may be pivotably connected at a proximal end of the stick to the body 110. The arm further comprises a tool 190. As shown in FIG. 2, the tool 190 may comprise a bucket. Alternatively, the tool may comprise other cutting or digging tools, for example a drill. The tool 190 may be pivotably connected at a proximal end of the tool 190 to a distal end of the stick 150 at a tool pivot 191.

The boom 130 may be configured to rotate about the boom pivot 131. For example, the boom 130 may be configured to rotate with respect to the chassis 109. The boom 130 may be configured to rotate about a horizontal axis through the boom pivot 131 in a plane perpendicular to the horizontal axis through the boom pivot 131. To cause rotation of the boom 130, the work machine 100 may further comprise a boom actuation assembly 120. The boom actuation assembly 120 may be connected at a proximal end of the boom actuation assembly 121 to the chassis 109 and at a distal end of the boom actuation assembly 125 to the boom 130. The boom actuation assembly 120 may be configured to extend and/or retract to cause a rotation of the boom 130 about the boom pivot 131. In some embodiments, the boom actuation assembly 120 may extend and/or retract between the proximal end of the boom actuation assembly 121 and the distal end of the boom actuation assembly 125. In some embodiments, the boom actuation assembly 120 may comprise a hydraulic actuator. In some embodiments, the boom actuation assembly 120 may comprise an electromechanical actuator. In some embodiments, the boom actuation assembly 120 may comprise an electrically driven motor located at the boom pivot 131 and configured to provide torque to rotate the boom 130 about the boom pivot 131.

The stick 150 may be configured to rotate about the stick pivot 151. For example, the stick 150 may be configured to rotate with respect to the boom 130. The stick 150 may be configured to rotate about a horizontal axis through the stick pivot 151 in a plane perpendicular to the horizontal axis through the stick pivot 151. To cause rotation of the stick 150, the work machine 100 may further comprise a stick actuation assembly 140. The stick actuation assembly 120 may be connected at a proximal end of the stick actuation assembly 141 to the boom 130 and at a distal end of the stick actuation assembly 145 to the stick 150. The stick actuation assembly 140 may be configured to extend and/or retract to cause a rotation of the stick 150 about the stick pivot 151. In some embodiments, the stick actuation assembly 140 may extend and/or retract between the proximal end of the stick actuation assembly 141 and the distal end of the stick actuation assembly 145. In some embodiments, the stick actuation assembly 140 may comprise a hydraulic actuator. In some embodiments, the stick actuation assembly 140 may comprise an electromechanical actuator. In some embodiments, the stick actuation assembly 140 may comprise an electrically driven motor located at the stick pivot 151 and configured to provide torque to rotate the stick 150 about the stick pivot 151.

The tool 190 may be configured to rotate about the tool pivot 191. For example, the tool 190 may be configured to rotate with respect to the stick 150. The tool 190 may be configured to rotate about a horizontal axis through the tool pivot 191 in a plane perpendicular to the horizontal axis through the tool pivot 191. To cause rotation of the tool 190, the work machine 100 may further comprise a tool actuation assembly 160. The tool actuation assembly 160 may be connected at a proximal end of the tool actuation assembly 161 to the stick 150 and at a distal end of the tool actuation assembly 167 to the tool 190.

In some embodiments, as shown in FIG. 2, the tool actuation assembly 160 may further comprise a tool manipulator 166. The tool manipulator 166 may comprise one or more idlers and/or power links. The rod end of the tool actuation assembly 165 may be connected to the tool manipulator 166, the tool manipulator comprising a distal end 167 connected to the tool 190. In other embodiments, not shown in FIG. 2, the rod end of the tool actuation assembly 165 may be connected to the tool 190 directly. The tool actuation assembly 160 may be configured to extend and/or retract to cause a rotation of the tool 190 about the tool pivot 191. In some embodiments, the tool actuation assembly 160 may extend and/or retract between the proximal end of the tool actuation assembly 161 and the rod end of the tool actuation assembly 165. In some embodiments, the tool actuation assembly 160 may comprise a hydraulic actuator. In some embodiments, the tool actuation assembly 160 may comprise an electromechanical actuator. In some embodiments, the tool actuation assembly 160 may comprise an electrically driven motor located at the tool pivot 191 and configured to provide torque to rotate the tool 190 about the tool pivot 191.

The method for monitoring an operation of a work machine 100 according to this disclosure may monitor one or more angles made by the arm 105 of the work machine 100. One or more angles which may be monitored will now be explained with reference to the first type of work machine 100 shown in FIG. 2. For the purpose of simplifying the diagram, any actuation assemblies which may be present are not shown in subsequent figures.

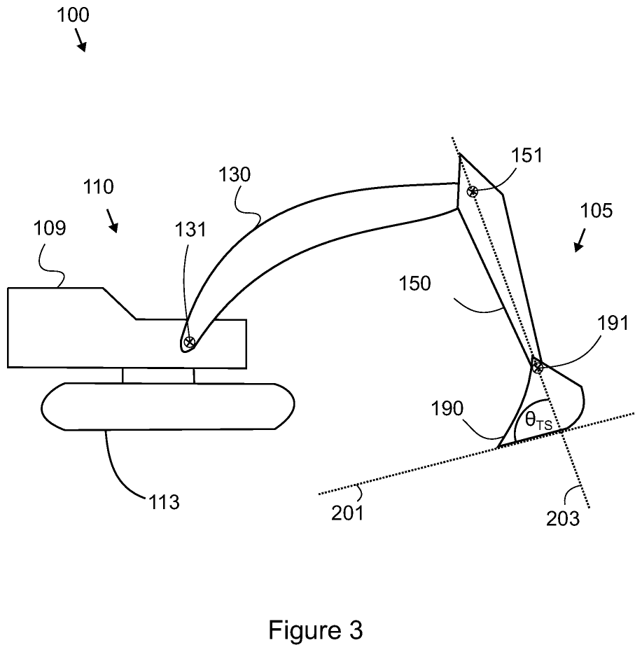

FIG. 3 shows a tool angle of rotation with respect to the stick (θ_{TS}) on the work machine 100.

The tool angle of rotation with respect to the stick (θ_{TS}) may comprise an angle between a tool axis 201 and a stick axis 203. The tool axis 201 may be any direction defined with reference to the tool 190. Similarly, the stick axis 203 may be any direction defined with reference to the stick 150. In the example of FIG. 3, the tool axis 201 is aligned with a cutting edge of the tool 190 and the stick axis 203 is aligned with an axis that intersects the stick pivot 151 to tool pivot 191. As will be explained in more detail below, because the force exerted and/or efficiency of the tool 190 when carrying out an operation may vary depending on a position of the stick 150 and a position of the tool 190, the tool angle of rotation with respect to the stick (θ_{TS}) may be monitored.

The force exerted and/or efficiency of the tool 190 when carrying out an operation may vary depending on a position of the tool 190, which may be monitored by monitoring the tool axis 201. If the tool axis 201 is aligned with the cutting edge of the tool 190, it may be preferable for the tool axis 201 to also be aligned with a direction of travel of the tool to ensure the tool 190 applies maximal cutting power in its direction of travel. The force exerted and/or efficiency of the tool 190 when carrying out an operation may vary depending on a position of the stick 150, which may be monitored by monitoring the stick axis 203. If the stick actuation assembly 140 is overextended and/or underextended, the force produced by the stick actuation assembly 140 may be non-optimal. As such, the efficiency of the tool 190 when carrying out an operation may depend on the orientation of the stick axis 203. As explained above, the tool angle of rotation with respect to the stick (θ_{TS}) may depend on both the tool axis 201 and the stick axis 203. Similarly, the force exerted and/or efficiency of the tool 190 may when carrying out an operation may also depend on both the tool axis 201 and the stick axis 203. Thus, by monitoring the tool angle of rotation with respect to the stick (θ_{TS}), information about the force exerted and/or efficiency of the tool 190 may when carrying out an operation may be obtained.

In FIG. 3, the tool axis 201, indicated by a dotted line, is shown as aligned with a cutting edge of the tool 190. The tool axis 201 may be geometrically derived from any other direction or axis defined with reference to the tool by addition or subtraction of an angular offset. By monitoring the tool axis 201, it is possible to monitor the position of the tool 190 and/or the orientation of the tool 190. For example, by monitoring the tool axis 201, it may be possible to monitor the orientation of the tool with respect to one or more of (i) an axis parallel to the tracks 113, (ii) an axis parallel to a surface of a section of material, (iii) a vertical axis, perpendicular to a surface of a section of material, (iv) a vertical axis aligned with the direction of gravity (v) an axis defined with respect to the boom 130, and/or any other externally defined axis and/or any axis defined with respect to the work machine 100.

In FIG. 3, the stick axis 203, indicated by a dotted line, is shown as extending from stick pivot 151 to tool pivot 191. The stick axis 203 may be geometrically derived from any other direction or axis defined with reference to the stick 150 by addition or subtraction of an angular offset. By monitoring the stick axis 203, it is possible to monitor the position of the stick 150 and/or the orientation of the stick 150. For example, by monitoring the stick axis 203, it may be possible to monitor the orientation of the stick 150 with respect to one or more of (i) an axis parallel to the tracks 113, (ii) an axis parallel to a surface of a section of material, (iii) a vertical axis, perpendicular to a surface of a section of material, (iv) a vertical axis aligned with the direction of gravity (v) an axis defined with respect to the boom 130, and/or any other externally defined axis and/or any axis defined with respect to the work machine 100.

In some embodiments, the tool 190 may comprise a cutting edge. In some embodiments, the tool 190 may comprise a bucket having a cutting edge at a distal of a bottom surface of the bucket. The cutting edge of the tool 190 may be aligned with a cutting direction of the tool.

The work machine 100 comprises a tool position sensor, configured to determine a position of the tool 190. The position of the tool 190 may comprise an orientation of the tool 190 and/or a spatial location of the tool 190. The orientation and spatial location may be determined with reference to the work machine 100, and/or a reference external to the work machine, such as the ground. The tool position sensor may comprise one or more of: (i) a tool gravity-based tilt sensor, (ii) a tool rotation sensor, (iii) a tool actuation assembly position sensor and the like.

In some embodiments, the work machine 100 further comprises a stick position sensor, configured to determine a position of the stick 150. The position of the stick 150 may comprise an orientation of the stick 150 and/or a spatial location of the stick 150. The orientation and spatial location may be determined with reference to the work machine 100, and/or a reference external to the work machine 100, such as the ground. The stick position sensor may comprise one or more of: (i) a stick gravity-based tilt sensor, (ii) a stick rotation sensor, (iii) a stick actuation assembly position sensor and the like.

In some embodiments, the work machine 100 further comprises a boom position sensor, configured to determine a position of the boom 130. The position of the boom 130 may comprise an orientation of the boom 130 and/or a spatial location of the boom 130. The orientation and spatial location may be determined with reference to the work machine 100, and/or a reference external to the work machine 100, such as the ground. The boom position sensor may comprise one or more of: (i) a boom gravity-based tilt sensor, (ii) a boom rotation sensor, (iii) a boom actuation assembly position sensor and the like.

In embodiments where the tool position sensor comprises a tool rotation sensor, the tool rotation sensor may be configured to determine an angle of rotation of the tool 190 about the tool pivot 191. In this way, the rotation sensor may be used to determine and/or measure the tool angle of rotation with respect to the stick (θ_{TS}) directly. In embodiments where the boom position sensor comprises a boom rotation sensor, the boom rotation sensor may be configured to determine an angle of rotation of the boom 130 about the boom pivot 131. In embodiments where the stick position sensor comprises a stick rotation sensor, the stick rotation sensor may be configured to determine an angle of rotation of the stick 150 about the stick pivot 151. By making use of the angle of rotation of the tool 190 about the tool pivot 191, angle of rotation of the boom 130 about the boom pivot 131, angle of rotation of the stick 150 about the stick pivot 151, and the dimensions of the boom 130, the stick 150, and the tool 190, the positions of the boom 130, the stick 150, and/or the tool 190 may be determined.

In embodiments where the tool position sensor comprises a tool actuation assembly position sensor, the tool actuation assembly position sensor may determine a length associated with an extension and/or retraction of the tool actuation assembly 160. In embodiments where the stick position sensor comprises a stick actuation assembly position sensor, the stick actuation assembly position sensor may determine a length associated with an extension and/or retraction of the stick actuation assembly 140. In embodiments where the boom position sensor comprises a boom actuation assembly position sensor, the boom actuation assembly position sensor may determine a length associated with an extension and/or retraction of the boom actuation assembly 120. By making use of the length associated with an extension and/or retraction of the tool actuation assembly 160, the length associated with an extension and/or retraction of the stick actuation assembly 140, and the a length associated with an extension and/or retraction of the boom actuation assembly 120, and the dimensions of the boom 130, the stick 150, and the tool 190, the positions of the boom 130, the stick 150, and/or the tool 190 may be determined. For example, the length associated with an extension and/or retraction of the stick actuation assembly 140, the length associated with an extension and/or retraction of the tool actuation assembly 190, and the dimensions of the stick 150 and the tool 190 may be used to determine the tool angle of rotation with respect to the stick (θ_{TS}).

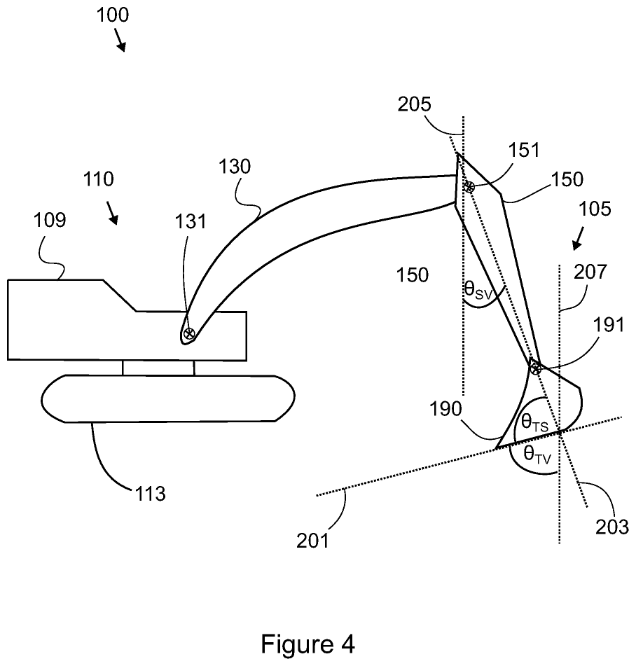

As has already been explained, in some embodiments, one or more of the tool position sensor, and, where present, the stick position sensor and the boom position sensor may comprise a gravity-based tilt position sensor. An embodiment where the tool position sensor comprises a gravity-based tilt sensor will be explained in detail below with reference to FIG. 4. The tool gravity-based tilt sensor may determine a tool orientation by determining a tool angle of rotation with respect to a gravity direction. The stick gravity-based tilt sensor may determine a stick orientation by determining a stick angle of rotation with respect to a gravity direction. The boom gravity-based tilt sensor may determine a boom orientation by determining a boom angle of rotation with respect to a gravity direction. Each of the tool gravity-based tilt sensor, the stick gravity-based tilt sensor, and/or the boom gravity-based tilt sensor may make an independent determination of a gravity direction. In this way, a determination of a position of the tool, the stick, and/or the boom, particularly of a distal component such as the tool, may be made with increased accuracy because there is less error propagation as a result of the independent measurements.

FIG. 4 shows a bucket angle of rotation with respect to a vertical line (θ_{TV}), a stick angle of rotation with respect to a vertical line (θ_{SV}), and a tool angle of rotation with respect to a stick (θ_{TS}), on a work machine. Vertical axes are indicated by dotted lines labelled 205 and 207. The vertical axes 205 and 207 may be aligned with the direction of gravity. Alternatively, the vertical axes 205 and 207 may be aligned perpendicular to a plane defined by the base of the ground propulsion assembly (e.g. the tracks 113).

In embodiments where the tool position sensor comprises a gravity-based tilt sensor, the orientation of the tool 190 may be determined with respect to a vertical axis aligned with the direction of gravity.

In some embodiments, the tool angle of rotation with respect to a stick (θ_{TS}) may be determined by:

θ_{TS}=180−(θ_{TV}+θ_{SV}) (1)
where the above equation is in units of degrees (°).

According to one or more aspects of this disclosure, a method for monitoring an operation of the work machine 100 is provided. The steps of the method will now be explained.

The method comprises:
determining, based on a determined position of the tool, a tool angle of rotation with respect to the stick; and
determining an output signal, based on comparing the tool angle of rotation with respect to the stick to a target range of tool angles.

In this way, the tool angle of rotation with respect to the stick may be monitored. The efficiency of an operation carried out by the arm 105 may depend on a position of the tool 190 and a position of the stick 150. Because the tool angle of rotation with respect to the stick (θ_{TS}) may depend on both the position of the tool 190 and the position of the stick 150, by monitoring tool angle with respect to the stick (θ_{TS}), it is possible to monitor the efficiency of the operation carried out by the arm 105.

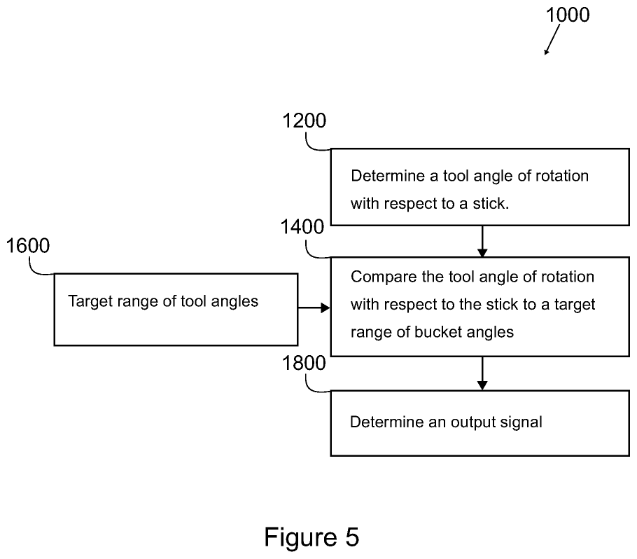

FIG. 5 shows an embodiment of a method 1000 for monitoring an operation of the work machine 100. The method 1000 comprises:
a step 1200 of determining, based on the determined position of the tool, a tool angle of rotation with respect to the stick;
a step 1400 of comparing the tool angle of rotation with respect to the stick (θ_{TS}) to a target range of tool angles;
a step 1600 of providing a target range of tool angles; and
a step 1800 of determining an output signal, based on comparing the tool angle of rotation with respect to the stick (θ_{TS}) to a target range of tool angles.

Examples of how each of these steps may be carried out will now be explained in more detail.

In some embodiments the step 1200 of determining, based on the determined position of the tool 190, a tool angle of rotation with respect to the stick (θ_{TS}) may be as follows. As has already been explained, the work machine 100 further comprises a tool position sensor, configured to determine a position of the tool 190. In some embodiments, the tool position sensor may comprise a tool rotation sensor. By using the tool rotation sensor, the tool angle of rotation with respect to the stick (θ_{TS}) may be determined directly. In other words, using a tool rotation sensor, the determined position of the tool may comprise the tool angle of rotation with respect to the stick (θ_{TS}), and as such the step 1200 may comprising a step of obtaining such data from the determination made by the tool rotation sensor.

In other embodiments, the tool angle of rotation with respect to the stick (θ_{TS}) may not be measured directly and may be derived from a tool position sensor and one or more other sensors. In some embodiments, the work machine 100 may further comprise a stick position sensor, configured to determine a position of the stick. In some embodiments, the tool angle of rotation with respect to the stick (θ_{TS}) may be derived from a tool angle of rotation with respect to a first reference direction θ_{TD1} and a stick angle of rotation with respect to the first reference direction θ_{SD1}. Thus, in some embodiments, the determined position of the tool 190 comprises a tool angle of rotation with respect to a first reference direction θ_{TD1} and the determined position of the stick 150 comprises a stick angle of rotation with respect to the first reference direction θ_{SD1}.

The tool angle of rotation with respect to the stick (θ_{TS}) may then be calculated based on a sum of the tool angle of rotation with respect to a first reference direction θ_{TD1} and the stick angle of rotation with respect to the first reference direction θ_{SD1}. By way of providing specific example, the following is explained where the first reference direction comprises a vertical direction. The vertical direction may be preferably aligned with the direction of gravity. Where the vertical direction is aligned with the direction of gravity, the tool angle of rotation with respect to vertical θ_{TV} and a stick angle of rotation with respect to vertical θ_{SV} may be determined by a tool gravity-based tilt sensor and/or a stick gravity based stick sensor. In this way, as has already been explained, the accuracy of the determined position may be improved since independent measurements of gravity direction may be made, resulting in reduced propagation of errors. By providing improved accuracy, the gains in efficiency by using the method 1000 may be increased.

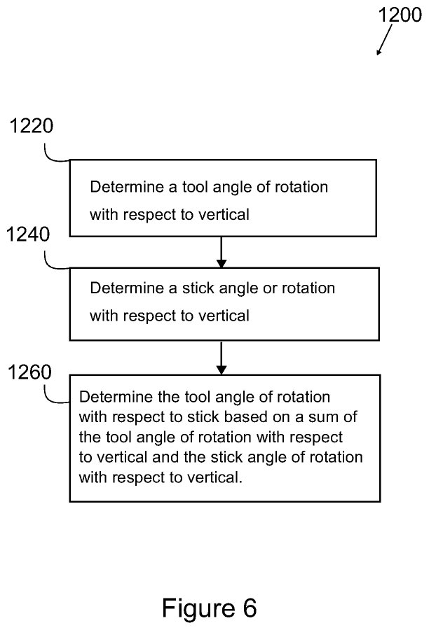

As has already been explained, in some embodiments, the first reference direction is a vertical direction, preferably aligned with the direction of gravity. FIG. 6 shows an embodiment of the step 1200 of determining, based on the determined position of the tool, a tool angle of rotation with respect to the stick, where the first reference direction is a vertical direction, preferably aligned with the direction of gravity. In the embodiment shown in FIG. 6, the tool angle of rotation with respect to the stick (θ_{RS}) is based on a tool angle of rotation with respect to vertical (θ_{TV}) and a stick angle of rotation with respect to vertical (θ_{SV}). In a step 1220, the tool angle of rotation with respect to vertical may be determined. For the purpose of determining the tool angle of rotation with respect to vertical (θ_{TV}), the work machine 100 may be provided with a tool gravity-based tilt sensor. In a step 1240, the stick angle of rotation with respect to vertical may be determined. For the purpose of determining the stick angle of rotation with respect to vertical (θ_{SV}), the work machine 100 may be provided with a stick gravity-based tilt sensor. In a step 1260, the tool angle of rotation with respect to the stick (θ_{TS}) is determined based on a sum of the tool angle of rotation with respect to vertical (θ_{TV}) and a stick angle of rotation with respect to vertical (θ_{SV}). For example, the tool angle of rotation with respect to the stick (θ_{TS}) may be determined from the tool angle of rotation with respect to vertical (θ_{TV}) and a stick angle of rotation with respect to vertical (θ_{SV}) by equation (1).

θ_{TS} and (θ_{TV}+θ_{SV}) may be supplementary angles, where supplementary angles are defined by the property that the sum of two supplementary angles is 180°. In other words:

θ_{TS}+(θ_{TV}+θ_{SV})=180° (2)

Because supplementary angles have a consistent geometric relationship, it will be understood that it is possible to monitor θ_{TS} indirectly by monitoring (θ_{TV}+θ_{SV}). Thus, the θ_{TS} need not necessarily be determined directly. It will be understood by those skilled in the art, that by providing one or more boom position sensor, stick position sensor, and/or tool position sensor, a plurality of quantities may be determined, which themselves have a consistent relationship with θ_{TS}. As such, it is alternatively possible to determine one or more of the plurality of quantities as a way of monitoring the tool angle of rotation with respect to the stick θ_{TS}.

Some embodiments of the step 1400 of comparing the tool angle of rotation with respect to the stick (θ_{TS}) to a target range of tool angles may be as follows. In some embodiments, the target range of tool angles may comprise a lower limit (θₘᵢₙ) and an upper limit (θₘₐₓ). In some embodiments, the tool angle of rotation with respect to the stick (θ_{TS}) may be compared to the target range of angles by checking if the following inequality is true:

θₘᵢₙ<θ_{TS}<θₘₐₓ (3)

Some embodiments of the step 1600 of providing a target range of tool angles may be as follows. In some embodiments, the target range of tool angles may be between around 70° and 90°. The midpoint of the target range of tool angles (in the above example, the midpoint of 70° and 90° would be around 80°) may depend on the definition of the tool axis and the stick axis. In some embodiments, the midpoint of the target range of tool angles may be determined such that the cutting edge of the tool 190 is aligned with the direction of travel of the tool 190. The direction of travel of the tool 190 may be defined as a direction of travel of a part of the tool 190 which is fixed with respect to the stick 150, such as the tool pivot 191. In this way, an increased cutting efficiency of the tool 190 may be provided.

In some embodiments, the midpoint of the target range of tool angles (θ_{midpoint}) may be given by:

θ_{midpoint}=0.5*(θₘᵢₙ+θₘₐₓ) (4)

The size of the range between the lower limit (θₘᵢₙ) and the upper limit (θₘₐₓ) may depend on (i) accuracy of the position sensors and/or (ii) precision of the actuation assemblies for making adjustments. In some embodiments, the size of the range may be given by:

Δθ=θₘₐₓ−θₘᵢₙ (5)

In some embodiments, the target range of tool angles may be determined based on a force optimisation and/or an energy optimisation algorithm. In some embodiments, the target range of tool angles may be determined based on user experience and/or provided by an expert user.

In some embodiments, the target range of tool angles may be a fixed target range of tool angles. For example, in an event that the boom 130 is stationary (e.g. the boom 130 is not rotating about the boom pivot 131), the direction of travel of the tool 190 may vary depending only on the rotation of the stick 150 about the stick pivot 151. As such, the midpoint of the target range of tool angles (θ_{midpoint}) may be a fixed value.

In some embodiments, the target range of tool angles may be a dynamic target range of tool angles. For example, in an event that the boom 130 is moved during an operation (e.g. the boom 130 is rotated about the boom pivot 131 during the operation), the direction of travel of the tool 190 may vary depending on the movement of the boom 130 and the moment of the stick 150. As such, the midpoint of the target range of tool angles (θ_{midpoint}) may be updated depending on the movement of the boom 130. For example, if the boom 130 is moved upwards during the operation, the midpoint of the target range of tool angles may be decreased. In this way, the tool 190 may be rotated upwards. If the boom 130 is moved downwards, the midpoint of the target range of tool angles (θ_{midpoint}) may be increased. In this way, the tool 190 may be rotated downwards.

Some embodiments of the step 1800 of determining an output signal, based on comparing the tool angle of rotation with respect to the stick 150 to a target range of tool angles may be as follows. In some embodiments, the step 1800 may comprise setting the output signal to a negative signal if the tool angle of rotation with respect to the stick (θ_{TS}) is outside a target range of the tool angle of rotation with respect to the stick (θ_{TS}); and/or setting the output signal to a positive signal if the tool angle of rotation with respect to the stick (θ_{TS}) is within a target range of the tool angle of rotation with respect to the stick (θ_{TS}). In some embodiments, the step 1800 may comprise setting the output signal based on whether or not the inequality (3) is true, as may have been determined in the step 1400. In some embodiments, if the inequality (3) is true, the step 1800 may comprise setting the output signal to a positive signal. In some embodiments, if the inequality (3) is false, the step 1800 further setting the output signal to a negative signal.

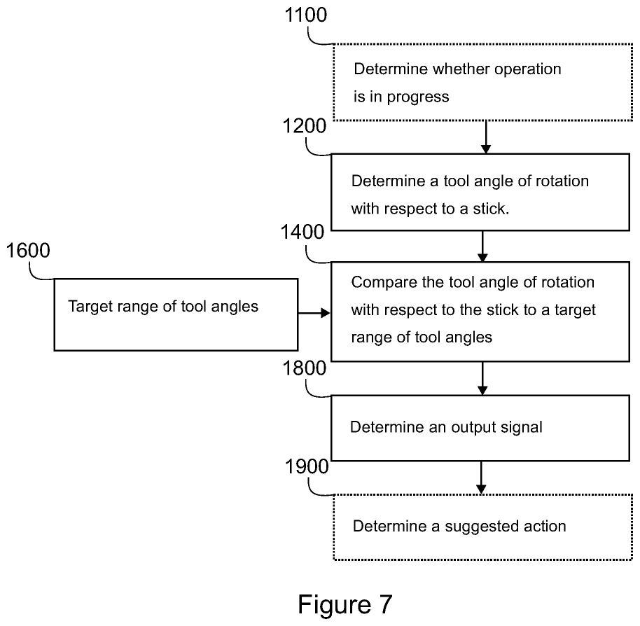

In some embodiments, the method 1000 may further comprises a step 1100 of determining whether an operation is in progress and/or, based on the output signal, a step 1900 of determining a suggested action. FIG. 7 shows an embodiment of method 1000 further comprising a step 1100 of determining whether an operation is in progress and/or a step 1900 of determining a suggested action.

In some embodiments, the step 1100 of determining whether an operation is in progress may comprise determining whether a dig operation is in progress. Determining whether an operation is in progress may be determined based on one or more of (i) boom position sensor and/or boom actuation assembly pressure sensor (ii) stick position sensor and/or stick actuation assembly pressure sensor, and (iii) tool position sensor and/or tool actuation assembly pressure sensor. As will be understood by those skilled in the art, whether an operation, such as a digging operation is in progress may be determined based on the data from one or more of the above noted sensors. For example, a “boom movement event” may correspond with a start of an operation. Alternatively, a machine learning algorithm may be used to determine whether an operation is in progress from data from one or more of the above noted sensors. Alternatively, a user instruction may be used to determine whether an operation is in progress.

In some embodiments, the step 1100 of determining whether an operation is in progress may comprise determining whether a dig operation is in progress prior to determining the output signal. This may avoid a situation where a suggested action and/or feedback is provided, despite no operation having been carried out. In some embodiments, the step 1100 may further comprise determining whether the boom 130 is being moved and/or whether a boom assist feature is activated. In some embodiments, it may be desirable to move the boom 130 in a situation where the tool 190 has become stuck, for example where the tool 190 is unable to move through or cut through material due to hardness or stiffness of the material. The tool 190 being stuck may lead to a situation where movement of the stick 150 or the tool 190 could cause the body 110 of the work machine 100 to rotate about the tool 190. This could result in the tracks 113 being raised off the ground. Such a situation may be avoided by raising or lowering the boom 130, for example by a user controlling the boom 130 and/or by a boom assist feature configured to automatically move the boom 130 in response to the tool 190 becoming stuck. As has been explained previously, because the movement of the boom 190 may affect the direction of travel of the tool 190, the output signal may be invalid if the boom 130 is moved during the operation, particularly in embodiments where the target range of tool angles is a fixed target range of tool angles. In some embodiments, based on determining whether the boom 130 is being moved and/or whether the boom assist feature is activated, the method 1000 may be terminated and/or the output signal indicated as invalid.

As has already been explained, see for example FIG. 2, the work machine 100 may further comprise: a stick actuation assembly 140 connected between the boom 130 and the stick 150, and configured to extend and/or retract to cause a rotation of the stick 150 about the stick pivot 151; a tool actuation assembly 160 connected between the stick 150 and the tool 190, and configured to extend and/or retract to cause a rotation of the tool 190 about the tool pivot 191.

In some embodiments, the method 1000 further comprises a step 1900 of determining a suggested action. In some embodiments, the step 1800 of determining the output signal, based on comparing the tool angle of rotation with respect to the stick (θ_{TS}) to the target range of tool angles may further comprise the step 1900 of determining a suggested action based on the tool angle of rotation with respect to the stick (θ_{TS}). In some embodiments, the suggested action comprises one or more of: (i) an instruction to extend and/or retract the stick actuation assembly 140; and/or (ii) an instruction to extend and/or retract the tool actuation assembly 160. By following the instruction, the user and/or controller 106 may cause the tool angle with respect to stick (θ_{TS}) to be adjusted back towards the target range of angles.

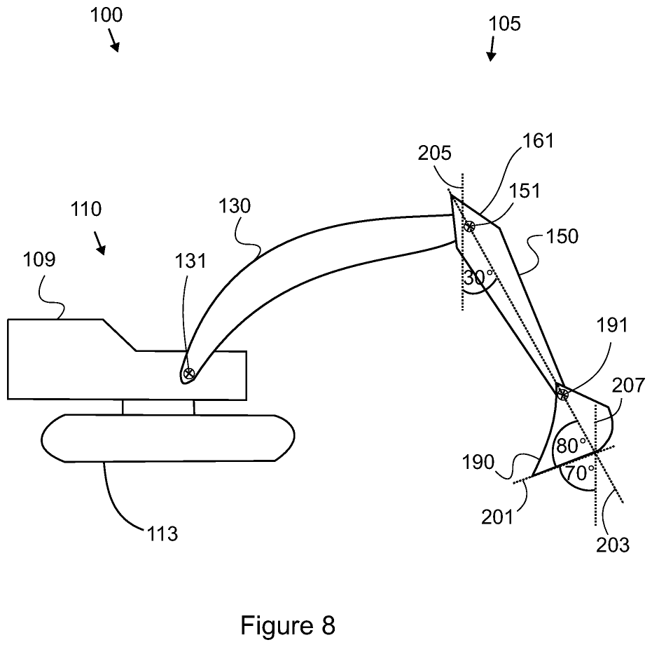

FIG. 8 shows the work machine 100 having a first tool angle of rotation with respect to the stick (θ_{TS}). In some embodiments, the first tool angle of rotation with respect to the stick (θ_{TS}) shown in FIG. 8 may be within the target range of angles. In the example shown in FIG. 8, the tool angle of rotation with respect to the stick (θ_{TS}) is 80°. In some embodiments, this may have been determined from the stick angle of rotation with respect to vertical (θ_{SV}) of 30° and the tool angle of rotation with respect to vertical (θ_{TV}) of 70° by using equation (1). As such, by following the method 1000, the output signal may be set to a positive signal. In some embodiments, the output signal may be provided to one or more of (i) the user interface 103 and/or (ii) a controller 106 for autonomously controlling the work machine 100. In such embodiments, based on receiving the positive signal, the user and/or controller 106 would be informed that the operation is proceeding/has proceeded efficiently. As such, the user and/or controller 106 may avoid altering the operation.

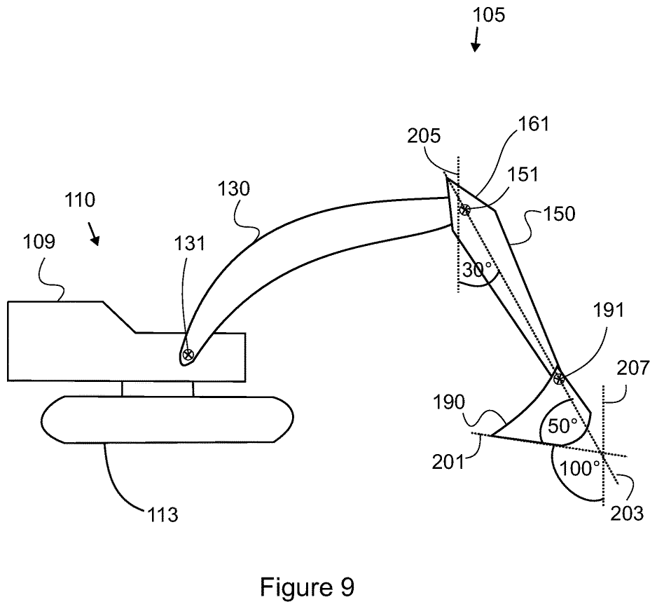

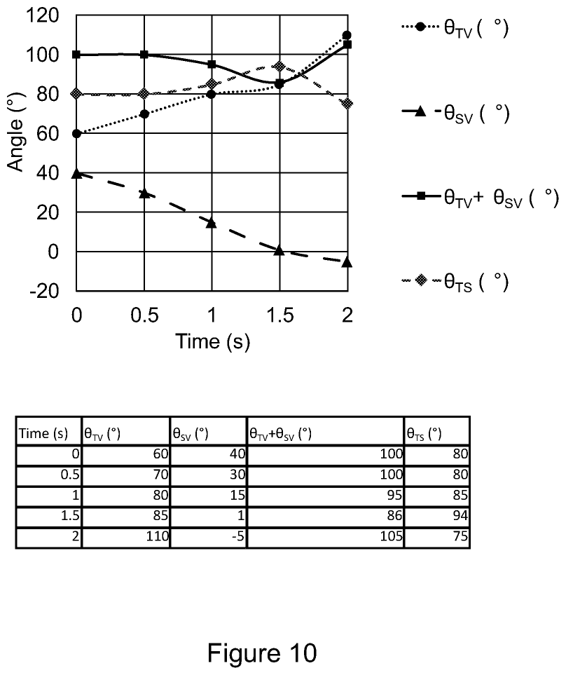

FIG. 9 shows a work machine having a second tool angle of rotation with respect to the stick (θ_{TS}). In some embodiments, the second tool angle of rotation with respect to the stick (θ_{TS}) shown in FIG. 8 may be outside the target range of angles. In the example shown in FIG. 9, the tool angle of rotation with respect to the stick (θ_{TS}) is 50°. In some embodiments, this may have been determined from the stick angle of rotation with respect to vertical (θ_{SV}) of 30° and the tool angle of rotation with respect to vertical (θ_{TV}) of 100° by using equation (1). Compared with FIG. 8, the work machine 100 shown in FIG. 9 may have had a user and/or controller 106 cause the tool 190 to curl upwards prematurely. As such, by following the method 1000, the output signal may be set to a negative signal. In some embodiments, the output signal may be provided to one or more of (i) the user interface 103 and/or (ii) a controller 106 for autonomously controlling the work machine 100. In such embodiments, based on receiving the negative signal, the user and/or controller 106 would be informed that the operation is not proceeding/has not proceeded efficiently. As such, the user and/or controller 106 may alter the operation.

As has already been explained the step 1800 of determining an output signal, based on comparing the tool angle of rotation with respect to the stick (θ_{TS}) to a target range of tool angles may further comprise a step 1900 determining a suggested action based on the tool angle of rotation with respect to the stick (θ_{TS}); wherein the suggested action comprises one or more of:
an instruction to extend and/or retract the stick actuation assembly 140; and/or
an instruction to extend and/or retract the tool actuation assembly 160.

The user and/or controller 106 may alter the operation based on the suggested action by following, as appropriate, the instruction to extend and/or retract the stick actuation assembly 140; and/or the instruction to extend and/or retract the tool actuation assembly 160. In the example shown in FIG. 9, the suggested action may comprise an instruction to extend the tool actuation assembly 160. Alternatively, the suggested action may comprise an instruction to retract the stick actuation assembly 140. Alternatively, the suggested action may comprise a combination of the instruction to extend the tool actuation assembly 160 and the instruction to retract the stick actuation assembly 140.

FIG. 10 shows (top) a plot at various time points as a digging operation is carried out of:
a tool angle of rotation with respect to a vertical line (θ_{TV}) (shown in FIG. 10 as a dotted line with circle shapes)
a stick angle of rotation with respect to a vertical line (θ_{SV}) (shown in FIG. 10 as a long dashed line with triangle shapes)
a sum of the tool angle of rotation with respect to the vertical line (θ_{SV}+θ_{TV}) (shown in FIG. 10 as a solid line with square shapes); and
the tool angle of rotation with respect to the stick (θ_{TS}) (shown in FIG. 10 as a short dashed line with diamond shapes;
and (bottom) a table summarising the data from the plot.

Following the line representing θ_{SV}, it can be seen that as the operation progresses, θ_{SV} goes from +40° to −5°. In this way, the stick 150 is rotated towards the chassis 109 of the work machine 100 to provide a digging action. During this operation, θ_{TV} correspondingly increases from 60° to 110°. In this way, the tool, for example a bucket, is progressively rotated with respect to the stick 150 as the operation progresses. In this way, a digging operation may be carried out between 0 and 2 s.

As has already been explained, the operation may be monitored according to method 1000 by monitoring θ_{TS}. As can be seen in FIG. 10, the line representing θ_{ST} is equal to constant of 80° for the first 0.5 s. In some embodiments, θ_{ST} may be within the target range of tool angles for the first 0.5 s. The target range of tool angles may be between 70° and 90°. At 1 s, Ors increases by to 85°. In some embodiments, θ_{TS} at 1 s may not be optimal, but may not have fallen outside the target range of tool angles. For example, if the target range of tool angles is between 70° and 90°, θ_{TS} of 85° would not fall outside the target range of tool angles. As such, a suggested action may not be determined or acted upon at 1 s. At 1.5 s, θ_{TS} increases further to 94°. In the example where the target range of tool angles is between 70° and 90°, θ_{TS} would now be outside the target range of tool angles. As such, a suggested action may be determined and acted upon at 1.5 s. At 2 s, θ_{TS} decreases to 75°. In the example where the target range of tool angles is between 70° and 90°, θ_{TS} would now be within the target range of tool angles. As such, the action taken based on the suggested action may have caused θ_{ST} to move to be within the target range of tool angles.

The sum θ_{SV}+θ_{TV} is also shown in FIG. 10. As has already been explained, θ_{TS} may be determined based on θ_{SV}+θ_{TV}, for example using equation (1). As can be seen in FIG. 10, θ_{SV}+θ_{TV} may follow a similar function with time to θ_{TS}, but θ_{SV}+θ_{TV} deviates from 90° by an opposite amount to θ_{TS}. This is because θ_{TS} and θ_{SV}+θ_{TV} may be supplementary angles.

As can be seen by the above example, the method 1000 may provide a negative feedback loop which may cause the θ_{TS} to fall within a target range of angles. This may improve the efficiency of the operation since the target range of angles may be determined for improved efficiency.

In some embodiments, the method 1000 may be used to review one or more entire work cycles and used to provide retrospective feedback.

Any of the above steps 1000 may be carried out using a data processing apparatus 107. The work machine 100 may comprise the data processing apparatus 107. The data processing apparatus 107 may comprise a memory, a processor, an input terminal for receiving data, and an output terminal for outputting the output signal. The data processing apparatus 107 may provide, from the output terminal, the output signal to one or more of the controller 106 and/or the user interface 103.

In some embodiments, the output signal may be updated at regular time intervals. For example, the output signal may be updated every 0.01 s, every 0.1 s and/or every 1 s. In some embodiments, the output signal may be updated at regular angular intervals, for example at regular intervals of a rotation of the stick 150 about the stick pivot 151. For example, the output signal may be updated as θ_{SV} changes by 0.1°, 1°, and/or 10°. In some embodiments, the output signal may be updated once per operation, for example once per complete operation, such as the operation between 0 and 2 s in FIG. 10. In some embodiments, the output signal may be updated at a time or angular interval set by a user and/or determined by the controller 106. In some embodiments, the output signal may be recorded. In some embodiments, the user interface 103 may comprise an output signal indicator. The output signal indictor may be set to a negative output signal indicator in an event that the output signal is a negative signal. The output signal indictor may be set to a positive output signal indicator in an event that the output signal is a positive signal. In some embodiments, the negative output signal indicator may remain until a user acknowledges the negative output signal indicator by an interaction with the user interface 103.

1. A method for monitoring an operation of a work machine, the work machine comprising a body and an arm, the arm comprising:
a stick, the stick comprising a proximal end pivotably connected to the body at a stick pivot and configured to rotate about the stick pivot;
a tool comprising a proximal end pivotably connected to a distal end of the stick at a tool pivot and configured to rotate about the tool pivot;
a tool position sensor, configured to determine a position of the tool;
wherein the method comprises:
determining, based on the determined position of the tool, a tool angle of rotation with respect to the stick; and
determining an output signal, based on comparing the tool angle of rotation with respect to the stick to a target range of tool angles.

2. The method of claim 1, wherein the work machine further comprises:
a stick position sensor, configured to determine a position of the stick; and
wherein the method further comprises:
determining, based on the determined position of the stick and the determined position of the tool, the tool angle of rotation with respect to the stick.

3. The method of claim 2, wherein:
the determined position of the tool comprises a tool angle of rotation with respect to a first reference direction; and
the determined position of the stick comprises a stick angle of rotation with respect to the first reference direction,
wherein the method further comprises:
determining the tool angle of rotation with respect to the stick based on a sum of the stick angle of rotation with respect to the first reference direction and the tool angle of rotation with respect to the first reference direction.

4. The method of claim 3, wherein,
the first reference direction is a vertical direction, preferably aligned with the direction of gravity.

5. The method of claim 1, wherein the step of determining an output signal, based on comparing the tool angle of rotation with respect to the stick to a target range of tool angles further comprises:
setting the output signal to a negative signal if the tool angle of rotation with respect to the stick is outside a target range of the tool angle of rotation with respect to the stick; and/or
setting the output signal to a positive signal if the tool angle of rotation with respect to the stick is within a target range of the tool angle of rotation with respect to the stick.

6. The method of claim 1, further comprising:
determining whether a dig operation is in progress prior to determining the output signal.

7. The method of claim 1, wherein the work machine further comprises:
a stick actuation assembly connected between the body and the stick, and configured to extend and/or retract to cause a rotation of the stick about the stick pivot;
a tool actuation assembly connected between the stick and the tool, and
configured to extend and/or retract to cause a rotation of the tool about the tool pivot;
and wherein the step of determining an output signal, based on comparing the tool angle of rotation with respect to the stick to a target range of tool angles further comprises:
determining a suggested action based on the tool angle of rotation with respect to the stick;
wherein the suggested action comprises one or more of:
an instruction to extend and/or retract the stick actuation assembly; and/or
an instruction to extend and/or retract the tool actuation assembly.

8. The method of claim 1, further comprising:
providing the output signal to one or more of:
a user interface; and/or
a controller configured to autonomously control the work machine.

9. The method of claim 1, wherein the tool comprises one or more of:
a bucket; and/or
a ground engaging tool; and/or
a drill.

10. The method of claim 1, wherein the target range of tool angles is a fixed target range of tool angles.

11. The method of claim 1, wherein the target range of tool angles is a dynamic target range of tool angles.

12. A data processing apparatus comprising means for carrying out the method of claim 1.

13. A work machine comprising a body and an arm, the arm comprising:
a stick, the stick comprising a proximal end pivotably connected to the body at a stick pivot and configured to rotate about the stick pivot;
a tool comprising a proximal end pivotably connected to a distal end of the stick at a tool pivot and configured to rotate about the tool pivot;
a tool position sensor, configured to determine a position of the tool;
a data processing apparatus for monitoring the operation of the work machine, the data processing apparatus being configured to:
determine, based on the determined position of the tool, a tool angle of rotation with respect to the stick; and
determine an output signal, based on comparing the tool angle of rotation with respect to the stick to a target range of tool angles.

14. The work machine of claim 13, further comprising:
a stick position sensor, configured to determine a position of the stick; and
wherein the data processing apparatus is further configured to:
determine, based on the determined position of the stick and the determined position of the tool, the tool angle of rotation with respect to the stick.

15. The work machine of claim 14, wherein:
the determined position of the tool comprises a tool angle of rotation with respect to a first reference direction; and
the determined position of the stick comprises a stick angle of rotation with respect to the first reference direction; and
wherein the data processing apparatus is further configured to:
determine the tool angle of rotation with respect to the stick based on a sum of the stick angle of rotation with respect to the first reference direction and the tool angle of rotation with respect to the first reference direction.

16. The work machine of claim 15, wherein
the first reference direction is a vertical direction, optionally aligned with the direction of gravity.

17. The work machine of claim 13, wherein as part of the step of determining an output signal, based on comparing the tool angle of rotation with respect to the stick to a target range of tool angles, the data processing apparatus is further configured to:
set the output signal to a negative signal if the tool angle of rotation with respect to the stick is outside a target range of the tool angle of rotation with respect to the stick; and/or
set the output signal to a positive signal if the tool angle of rotation with respect to the stick is within a target range of the tool angle of rotation with respect to the stick.

18. The work machine of claim 13, wherein the data processing apparatus is further configured to:
determine whether a dig operation is in progress.

19. The work machine of claim 13, further comprising:
a stick actuation assembly connected between the body and the stick, and configured to extend and/or retract to cause a rotation of the stick about the stick pivot;
a tool actuation assembly connected between the stick and the tool, and
configured to extend and/or retract to cause a rotation of the tool about the tool pivot;
wherein as part of the step of determining an output signal, based on comparing the tool angle of rotation with respect to the stick to a target range of tool angles, the data processing apparatus is further configured to:
determine a suggested action based on the tool angle of rotation with respect to the stick;
wherein the suggested action comprises one or more of:
an instruction to extend and/or retract the stick actuation assembly; and/or an instruction to extend and/or retract the tool actuation assembly.

20. The work machine of claim 13, further comprising:
providing the output signal to one or more of:
a user interface; and/or
a controller configured to autonomously control the work machine.

21. The work machine of claim 13, wherein the tool comprises one or more of:
a bucket; and/or
a ground engaging tool; and/or
a drill.

22. The work machine of claim 13, wherein the target range of tool angles is a fixed target range of tool angles.

23. The method of claim 13, wherein the target range of tool angles is a dynamic target range of tool angles.
